(19) United States
(12) Patent Application Publication
(10) Pub. No.: US 2007/0149247 A1
(43) Pub. Date: Jun. 28, 2007

(54) Intermediate bridge

(76) Inventor: C.M. Wong, Scarborough (CA)

Correspondence Address: JAMES ALAN FRANKLIN, 7901 RAVENSWOOD RD, GRANBURY, TX, 76049, US

(21) Appl. No.: 11/430,476

(22) Filed: May 8, 2006

Related U.S. Application Data
(63) Continuation-in-part of application No. 11/319,342, filed on Dec. 27, 2005.
(60) Provisional application No. 60/774,536, filed on Feb. 18, 2006.

(51) Int. Cl. H04B 1/38; H04M 1/00; H04B 1/08

(52) U.S. Cl. 455/557; 455/349

(57) ABSTRACT

A device facilitating transmission of audio and video content to an in-vehicle entertainment system through a wireless communication device, such as a cell phone. The wireless communication device is configured to download the content from a depository and either directly or through a bridge provides the content to the entertainment system.

### CROSS-REFERENCE TO RELATED APPLICATIONS

This application claims priority to co-pending United States provisional application entitled, “VPA/FM Hands-Free Transmitter,” having Ser. No. 60/691,670, filed Jun. 16, 2005; and to co-pending United States provisional application entitled, “Intermediate Bridge,” having Ser. No. 60/774,536, filed Feb. 18, 2006; which applications are entirely incorporated herein by reference. This application is also a continuation in part of U.S. utility application entitled, “Intermediate Modulator for Wireless Communication Devices,” having Ser. No. 11/319,342, filed Dec. 27, 2005, which is entirely incorporated herein by reference.

### BACKGROUND

1. Field

The disclosed embodiments relate generally to the delivery of audio and video information to audio and video systems through wireless devices, such as cell phones.

2. Discussion of the Prior Art

The wireless revolution has gripped our society with unprecedented attachment rate and consumer enthusiasm. Cell phones, at first expensive and uncommon, today are a commodity and for most a staple of every day life. Range of use is expansive. People use cell phones as safety devices, as means to stay in touch with friends and family, and even as entertainment pods. One can download games, ring tones, pictures, music files, video files, and world-wide-web content.

Another area of explosive enhancement is the video industry. Not long ago, FM radios, VHS players and DVD (digital video disk) players were high value-add items, delivering higher fidelity and sold at a premium in vehicles and home use. With time, these devices are becoming more common in today's vehicles. Now almost every vehicle is shipped with an FM band radio, many have integrated DVD players, and almost every home has one or more FM radio receivers.

Another relatively recent phenomenon is the ability for a user to download music and video from a central depository, such as his/her own music and/or video bank, or a vendor music and/or video bank that charges a fee. Such use is further fueled by the introduction of iPod brand players, which are essentially portable disk drive appliances that are optimized for storage and play of music and video content. The iPod and cell phone features are becoming integrated.

Cell phones are also evolving as entertainment pods. Cell phone providers allow its users to access the world-wide-web/internet to download information, check electronic mail, search the web, download games, ring tones, video and music. Once the music and/or video files are downloaded, the user can listen to it through the phone's miniature speaker or headphones. Similarly, the user could watch video information on the video display/screen. However, the user does not have the means to display/play the downloaded content through the electronic appliances in the vehicle, such as its audio and video equipment, which typically provide better fidelity sound and better quality viewing than a portable display of an iPod or a cell phone.

### SUMMARY

The disclosed embodiments provide a bridge from a communication device, such as a cell phone, to the vehicle's entertainment system, typically consisting of an audio and/or video device/system. The audio system typically comprises an antenna, a tuner, a FM or AM radio demodulator, one or more amplifiers and speakers (audio transducers). The video system typically comprises a video player, such as a DVD player, coupled a tuner in some, a video screen, such a LCD or plasma. The video and audio systems are often interconnected.

In one embodiment, the digital audio or video content is stored in or downloaded to the communication device. It is then decoded in the communication device, converted to an analog signal and is communicated to a bridge. The bridge frequency or amplitude modulates the content (FM, AM) and delivers the FM or AM signal to the audio system either wirelessly through its antenna or by coupling to the antenna for better reception. The audio device then amplifies and displays/plays the delivered audio content through one or more speakers/audio transducers.

The disclosed embodiments foresee that the digital content could be compressed or uncompressed. For example, the content delivered to the communication device could be uncompressed. In which case, the content then flows to the audio system through the described bridge. On the other hand, the content could be delivered in a certain format, such as MP3 as an example. Therefore, at one or more points in the chain of the communication device, the bridge and the audio system, the content will be decompressed.

In another embodiment the audio signal is decoded and decompressed at the communication device, converted to an analog signal and delivered to the audio system via a physical path, such as a coaxial cable. The audio system then amplifies and displays/plays the delivered audio content.

In another embodiment the audio signal is received by the communication device, decoded and decompressed to its digital content and then delivered to the audio system via a physical path, such as a coaxial cable. The audio system employs a digital to analog converter to convert the digital content to its analog form, amplifies and then displays/plays the delivered audio content.

In another embodiment a communication device employs video decoding functionality, such as an MPEG decoder, sends the decoded video and audio signals to the video and audio systems via a coaxial, RGB, DVI or a suitable cable(s)/path(s), which in turn display the audio and video content. The video is displayed on a screen, while the audio content is typically routed to the audio system, where it is amplified and displayed.

In an alternate embodiment the communication device sends a compressed digital stream to the video system/display, which uses its accessible video decoder to decompress and display the video and audio content. The audio content is typically routed to the audio system, where it is amplified and displayed.

In another embodiment a communication device having decoding functionality sends the decoded video and audio content to an intermediary bridge via the UWB (Ultra Wide Band) and/or Bluetooth protocols. The bridge receives the signal, demodulates it and depending on the configuration decompresses and delivers it to the audio system and video system/display via a coaxial, RGB, DVI or a suitable cable(s)/path(s), which in turn display the content. The video content is displayed on a screen, while the audio content is typically routed to the audio system, where it is amplified and displayed.

In another embodiment a communication device sends the MPEG encoded video and audio content to an intermediary bridge via the UWB or Bluetooth intermediary/short range protocol. The bridge receives the signal, demodulates it and if received in compressed form it decompresses the MPEG stream using its on-board video decoder. The decoded string is converted to an analog video signal and is either delivered via physical cable/path as described above; or in an alternate embodiment, the signal is encoded onto a carrier for short range transmission to the video system. The delivery could be by means of a wireless radio frequency using the video display's antenna and tuner, or via a coaxial, RGB, DVI or a suitable cable(s)/path(s). The video is displayed on a screen, while the audio content is typically routed to an audio system, where it is amplified and displayed.

Similarly, in an alternate embodiment, the bridge could be implemented as an integral part of the video or audio system.

### BRIEF DESCRIPTION OF THE DRAWINGS

FIG. 1 illustrates a representative diagram of two exemplary embodiments of the bridge communicating audio content from the communication device to the audio system;

FIG. 2 illustrates a representative diagram of an alternate exemplary embodiment, wirelessly coupling the communication device with the bridge device;

FIG. 3 illustrates a diagram of an alternate embodiment, wherein the bridge device is integrated into the communication device;

FIG. 4 illustrates a diagram of an alternate embodiment, wherein the audio content is demodulated at the communication device and is delivered to the audio system as an analog signal via a physical link for amplification and display;

FIG. 8 illustrates a diagram of an alternate embodiment, wherein the audio content is demodulated at the communication device and is delivered to the audio system in its digital form via a physical link for conversion, amplification and display;

FIG. 6 illustrates a diagram of an alternate embodiment, employing a bridge receiving the audio content in its digital form from the communication device, converting it to an analog signal and coupling the delivering the analog signal to the audio system for amplification and display;

FIG. 7 illustrates a diagram of an alternate embodiment employing a communication device comprising a video decoder coupled to a video display, where the video content is decoded at the communication device and delivered to the display via a suitable cable;

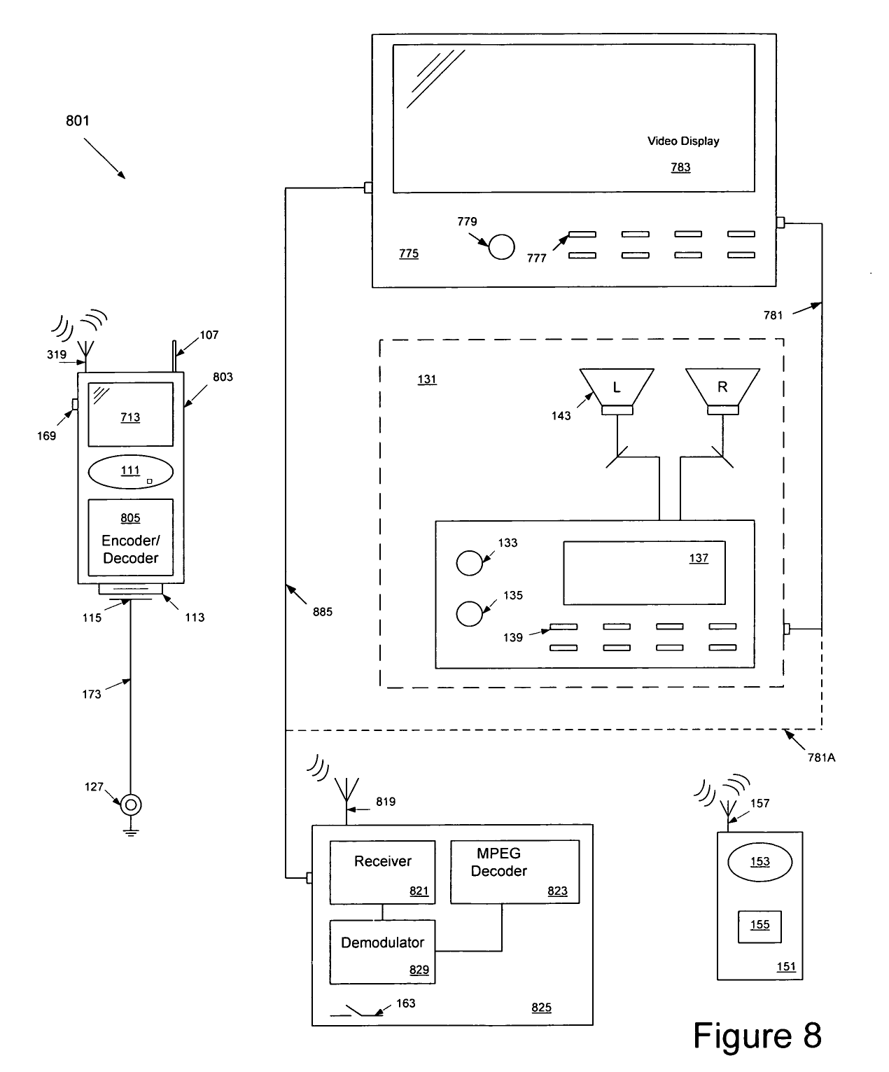

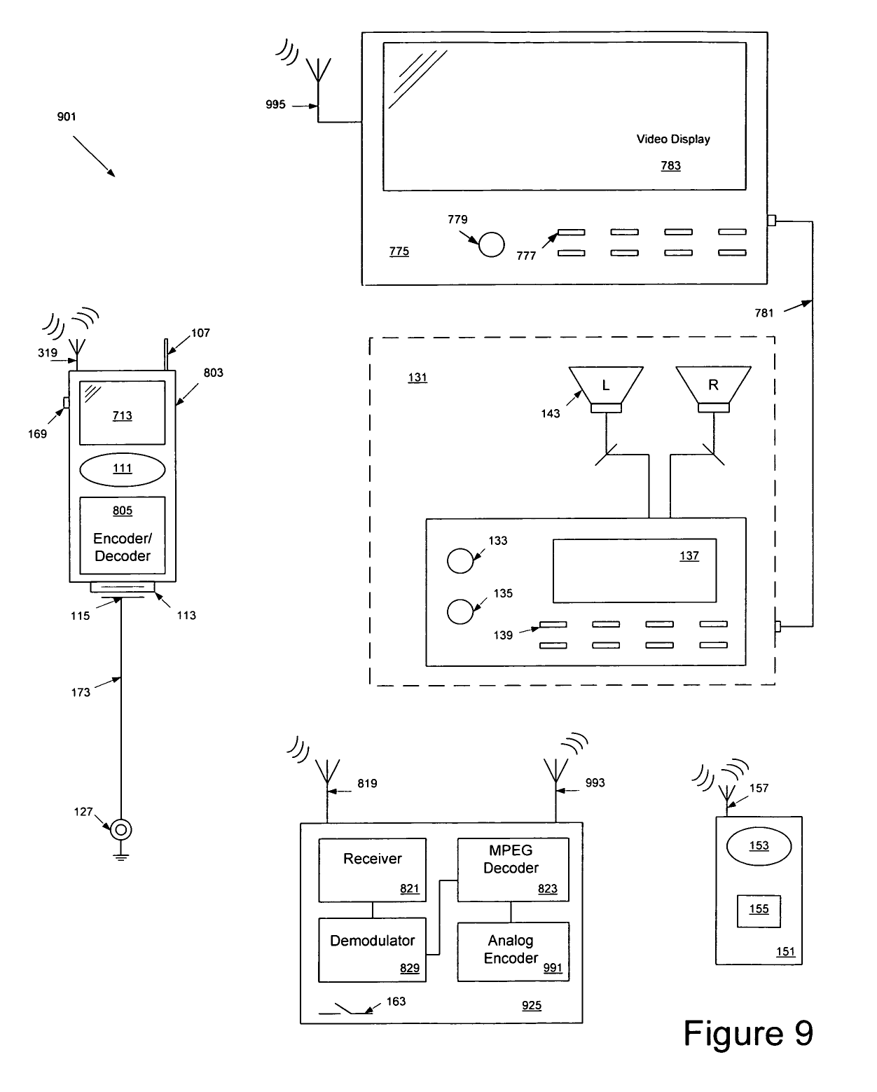

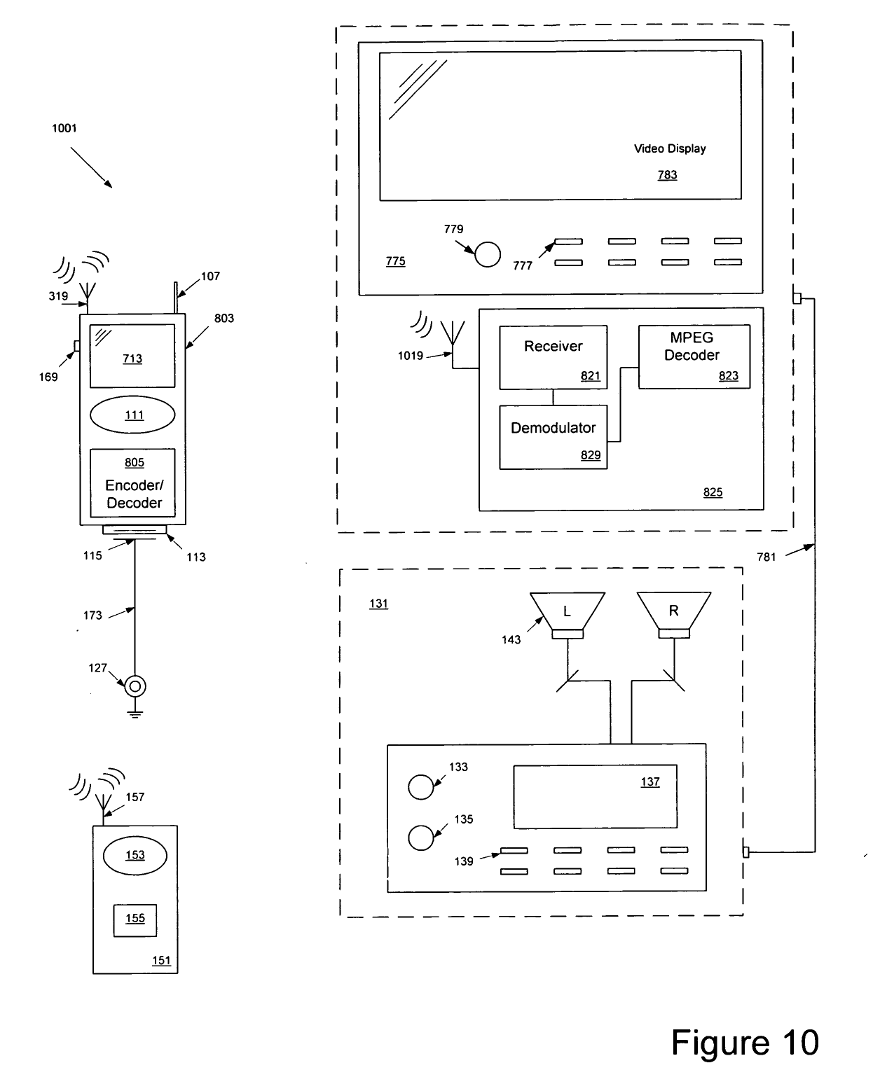

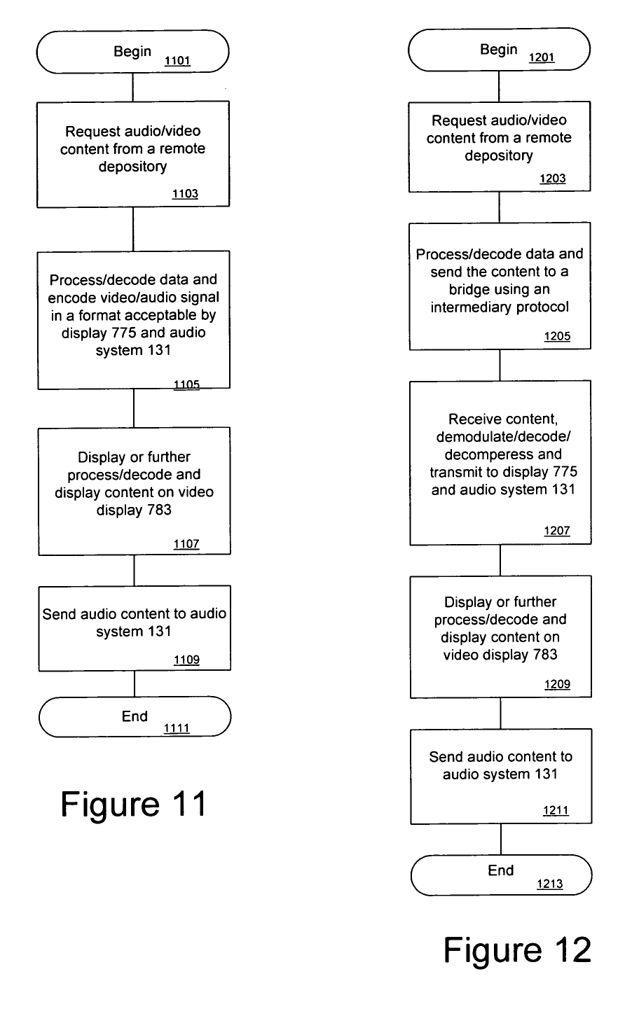

FIG. 8 illustrates a diagram of an alternate embodiment employing a communication device comprising a Bluetooth and/or UWB encoder; a bridge with a Bluetooth and/or UWB demodulator and a video decoder, coupled to a video display, where the video content is decoded at the bridge and delivered to the display via a suitable cable;

FIG. 9 illustrates a diagram of an alternate embodiment employing a communication device comprising a Bluetooth and/or UWB encoder; a bridge with a Bluetooth and/or UWB demodulator, a video decoder, and an analog encoder, where the content, including the video, is wirelessly coupled to a video display having wireless receiving capability to receive and display the content;

FIG. 10 illustrates a diagram of an alternate embodiment employing a communication device comprising a Bluetooth and/or UWB encoder and a display device with an integrated bridge; wherein the bridge employs a Bluetooth and/or UWB demodulator and a vide decoder coupled to a video display;

FIG. 11 is a flowchart illustrating the process for requesting, receiving and delivering the video and/or audio content to the video display and the audio system;

FIG. 12 is a flowchart illustrating the process for requesting, receiving and delivering the video and/or audio content to the video display and the audio system through an intermediary bridge.

### DETAILED DESCRIPTION

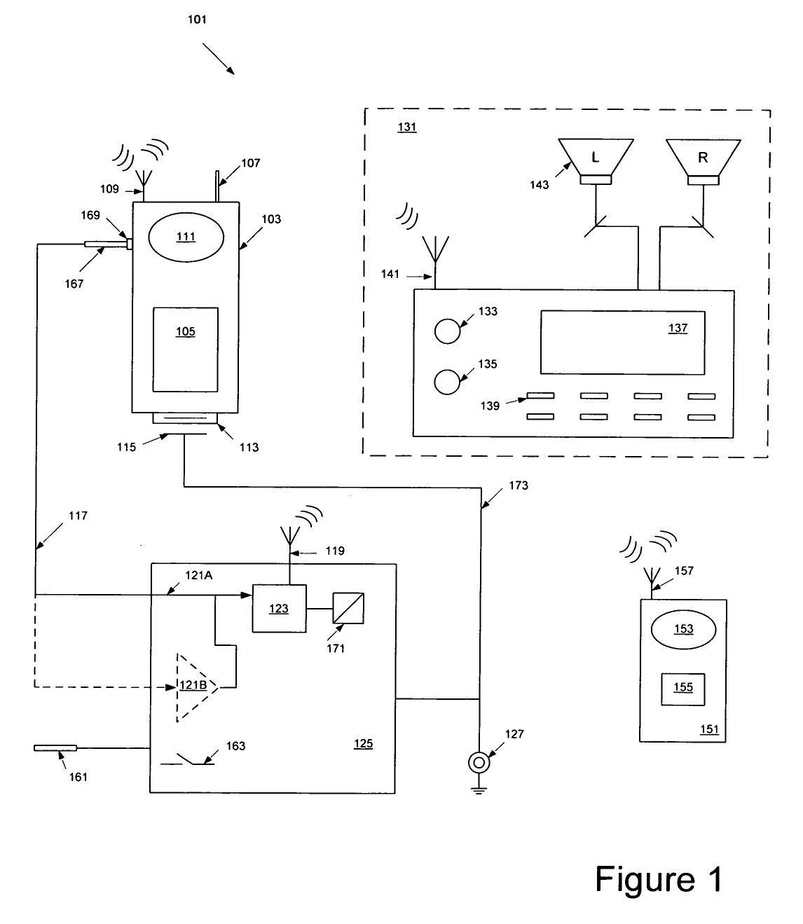

Shown in FIG. 1, is a representative embodiment of the disclosed system 101. System 101 generally comprises a wireless communication device 103, such as a cell phone, including an integral audio display device, such as an audio transducer/speaker 111. It is understood, however, that the structure described herein will work equally well with any wireless communication device capable of downloading digital files. For example, it is foreseeable that portable computers or PDAs may have such capability and any such devices are within the scope of device 103. Looking far enough in advance, as one example, such capability may exist on wristwatches as well.

Typically, the downloaded files reach device 103 through its antenna 107, which could be in or out of physical view to the user. Device 103 then employs a decoder 105 to decode the signal in accordance with the protocols, algorithms and/or specifications (collectively throughout the “protocols”) defined by the network carrier. For example, the predominant protocols today are CDMA and GSM, although such protocols have no impact on the disclosed embodiments. Once the downloaded files are decoded, they are stored in a memory or buffer (not shown). Such memory is typically aboard one or more of the described devices. One may also store such files on a removable memory medium (not shown) such as a memory card or a disk for subsequent play on the device 103 or other devices. The derived files may have arrived in compressed form. A common compression protocol for music files is MP3, while a common protocol for video files is MPEG or H.264 (hereafter collectively “video protocols”). Other protocols may also be used. Accordingly, decoder 105 is also configured with the ability to recognize one or more compression protocols, such as MP3 and/or video protocols as a part or in addition to its decoding function, to decompress the downloaded file in accordance with one or more of such protocols. Once decompressed, typically the wireless device is ready to display the audio or video content through its speaker 111 or display 713 or to provide the audio signal to external ear phone(s).

Yet in another embodiment, device 103 may also comprise intermediary transmission capability, wherein the received files are broadcast from device 103 to other devices in the vicinity. One such intermediary transmission protocol is commonly referred to as Bluetooth. Bluetooth is an industry adopted protocol for relatively short range transmission of digital information. To achieve higher throughput, desirable in video applications, one may choose to use a UWB (ultra wide band) platform. UWB is a short range, high throughput protocol allowing short range, high speed interconnect between two or more devices. In one alternate embodiment, device 103 is Bluetooth and/or UWB enabled and it broadcasts the downloaded digital files via its antenna 109 to receivers or transceivers in its vicinity, such as a transceiver 151.

Once the intermediary signal is sent by device 103, one or more remote receivers can receive the signal. In one example a remote transceiver 151 receives the signal via its antenna 157. In this particular example, device 151 is a wireless transceiver or headset used to communicate audio information to and from the wireless communication device 101. This device is configured for removable attachment about the user's ear and it allows the user to communicate with another party through his/her cell phone 103. Transceiver 151 employs an audio transducer 153 to display the audio content to the user. As in the case of audio transducer 111, audio transducer 153 could be a magnetic or a piezo speaker, ear bud(s) or a headphone. Given its function, transceiver 151 also typically includes a microphone 155 that generates an electrical signal in response to the audio energy that it senses. In turn, transceiver 151 transmits the generated audio signal back to device 103 via the Bluetooth protocol or one or more other intermediary transmission protocols. One of ordinary skill in the art will recognize how to digitize the electrical signal generated by microphone 155, encode it as a Bluetooth signal (as one example) and transmit it back to device 103 via its antenna 157. One will also appreciate that transceiver 151 in this embodiment comprises a decoder (such as Bluetooth decoder) for decoding the intermediary signal, a digital to analog converter and an amplifier, configured to generate the audio signal at transducer speaker 153. Similarly, one will also appreciate that transceiver 151 in this embodiment comprises the blocks necessary for the reverse link, including without limitation an analog to digital converter, signal conditioning circuitry, an encoder (such as Bluetooth encoder) for encoding the intermediary signal for transmission to the wireless communication device 103 and other devices in its vicinity. Some remote devices are receivers only. An example is a wireless headset. Such devices would typically employ only receiving and decoding functionality. Other devices, such as the described headset 151, need a two-way capability, and therefore employ receiving, transmitting, encoding and decoding functionality.

As mentioned above, a typical communication device 103 has the inherent ability to display the audio content of downloaded files through its display device 111. However, in some environments, display device 111 is insufficient. In one example, speaker 111 may not be powerful enough in a noisy environment, it may not have sufficient quality characteristics, or the user may simply want to take advantage of the utility and the convenience of the audio equipment 131 in the vicinity. Missing, however, is the link between the device 103 and audio equipment/system 131.

In its simplified form, typical audio system 131 comprises a tuner/amplifier (not shown) connected to an antenna 141, displaying the audio content through one or more audio transducers/speakers 143. Commonly this combination is referred to as a radio or a radio receiver. More particularly, audio equipment 131 is configured to receive a signal comprising audio content on a carrier frequency that is frequency modulated (FM) or amplitude modulated (AM). The carrier frequencies are picked up by antenna 141 and are fed to an input of an AM or FM tuner and then a FM or AM demodulator. The tuner looks at the signal from antenna 141 about the frequency parameters selected by the user. Typically the user will use one of the control knobs such as knob 133 to select the frequency, often referred to as the “channel” or “station.” Also common, is for the user to preset the stations he/she often listens to and store them in registers invoked by switches 139. Therefore, if a user has a preference for a station, he/she would program that station frequency in the resident memory and recall that frequency by pressing switch 139. Often, the selected frequency information, such as the station name, the frequency number, control information such as volume, and other pertinent data are displayed on display 137. The other control knob 135 optionally allows the user to control other parameters of the audio equipment 131, such as volume, tuning, balance between the speakers, and sound tone. Once the tuner tunes to the selected frequency, the demodulator of audio equipment 131 in turn derives the audio content. That content is then amplified and displayed through one or more audio transducers/speakers 143.

As mentioned above, although audio equipment device 131 and wireless communication device 103 are both receiving information wirelessly, they are typically incompatible.

Described is bridge 125 bridging device 103 and audio system 131, using one of the established FM or AM protocols. Depending on the manufacturing and marketing criteria, its power source 127 could be a battery, onboard power source gathered by plugging into a harness or the cigarette lighter of a vehicle, or any other power means. In one embodiment, demodulator 105 decodes the received signal to derive the digital file. As mentioned above, the downloaded file(s) may also be compressed using one of a number of available compression protocols. One of the more common protocols for music content is the MP3 compression. Others exist as well. One of ordinary skill in the art would be able to put in the right components to handle the protocols and formats of the incoming signals and data to extract the digital file representing the downloaded audio and/or video content. The functional or hardware blocks may be separate from or integral to decoder 105 without detracting from the contribution of the disclosed embodiments.

In one embodiment, demodulator 105 converts the downloaded file(s) into its analog audio content. The content is then displayed through audio transducer/speaker 111 and/or provided to bridge 125 and/or transceiver 151 and/or other devices. Described next are embodiments collectively illustrated as bridge 125. However, it is understood that any configuration alone or in combination with one or more of the disclosed embodiments denoted by blocks 121A and 121B and communication paths between device 103 and 125 are within the scope of this description.

In one embodiment, the audio content is received by device 103, demodulated, decompressed, if received in compressed form, and the digital information is converted to an analog signal. Typical compression protocol for music files is MP3. Although any compression protocol is suitable, as long as the wireless communication device 103 is configured with the corresponding decompression protocol. The analog signal is provided to bridge 125 via a wired path 117. In this embodiment the signal follows a path 121A, which leads it directly to or through some signal conditioning to FM or AM modulator 123. On one end, wired path 117 terminates in a connector 167, which is configured for compatibility with connector 169 of device 103. Typically connector 169 is an ear-bud or headphone connector configured to operate with headsets for cell phones. On the other end, wired path 117 is hardwired into bridge 125 or is configured for removable connection with bridge 125 using a suitable connector pair. After some signal conditioning or signal processing such as an attenuator (not shown), modulator 123 then FM or AM modulates (or any other modulation compatible with the audio system 131) the audio content received from device 103 on a signal with a frequency (channel or station) compatible for receipt by audio equipment 131. Shown in FIG. 1 is a frequency selector 171. It allows the user to choose the center frequency for such modulation. However, one or several defined frequency selections may also be used. Embodiment employing frequency selector 171 allows the user to define the frequency on which the downloaded content will be sent to audio system 131. This avoids the potential of having a predefined frequency overlap with a station frequency preferred by the user and it allows the user to select one or more frequencies that are relatively noise free. The modulated signal is then transmitted through antenna 119 to antenna 141 of audio system 131. Audio system 131 in turn demodulates the signal and displays its content through one or more speakers 143.

Power is provided to bridge 125 from a power source 127, which typically ranges from 11 Vdc to 15 Vdc, although any current or power source could be conditioned to suitable parameters. In one of the embodiments power source 127 is accessible through a cigarette lighter port typically available in a vehicle. However, any port having one or more power outputs will suffice. Depending on the design, the power is then channeled via path 173 to bridge 125 and optionally to device 103. Device 103 may use such power availability to recharge its internal power reserves. At 103, path 173 terminates in a connector 115 compatibly suitable for connection with connector 113. In an alternate embodiment power source 127 represents battery power reserves available internally or externally to bridge 125. Once again, one may extend that reserve to device 103 via path 173. Shown is a microphone 161 allowing the user to communicate with another party over device 103 or to provide audible commands to device 103 and/or audio equipment 131, device 125 and/or any other device in the system. Microphone 161 may be integrated into path 117 or 173 stemming from the power plug 127 leading to device 103, essentially substituting for the headset microphone. However, microphone 161 may be placed at any point in the vicinity of the user.

In one embodiment, path 173 may be configured as a stretchable wire coil. As a coil, the physical connection is more manageable and efficient, especially in a relatively confined space typical of a vehicle environment. Such design is more compact and yet it accommodates some movement while minimizing the wire tangling associated with longer wired paths. One or more switches and/or soft switches 163 may be employed to switch on and off the functionality of bridge 125 and/or mute microphone 161. Switch 163 could also be used to pick up an incoming call or terminate a call.

Bridge 125 may also be integrated with path 173 and/or into the male cigarette lighter plug typically associated with an in-cabin power connection. Such plugs typically accommodate enough physical space for the user to grip and insert the plug into the female power receptacles. In one embodiment, bridge 125 is integrated into the body of the male plug 127. Of course, such integration is not functionally necessary, although logically desirable for efficiency and aesthetics. Bridge 125 could also be designed as a separate physical module configured for interoperability as described throughout this disclosure.

In another embodiment, path 121B is employed. This embodiment accepts the audio content in its digital form from device 103 through wired path 117. The physical connection in this embodiment could vary, but one logical choice is USB. In this embodiment, connectors 167 and 169 are corresponding USB connectors. The audio content is received by device 103, demodulated by demodulator 105, as applicable decompressed and provided to bridge 125 or decompressed at 125. Logically, the decompression would take place at demodulator 105 of communication device 103, since device 103 will likely have such decompression protocol and the necessary hardware for this and other applications. However, the same capabilities could be placed in bridge 125. Once the content file is derived, either at device 103 or at bridge 125, bridge 125 is configured to employ a digital to analog converter (DAC) 121B. DAC 121B converts the digital content into an analog signal and provides it to modulator 123. As described above, modulator 123 then FM or AM modulates (or any other modulation compatible with audio system 131) the audio content received from device 103 on a signal with a frequency (channel, station) compatible for receipt by audio equipment 131. The modulated signal is then transmitted through antenna 119 to antenna 141 of audio system device 131. Audio system 131 in turn demodulates the signal and displays its content through one or more speakers 143.

It is understood that the dashed line and the inclusion of illustrated blocks 121A and 121B suggest that depending on the design criteria, one could adopt any one of the alternate embodiments. One could also choose to include both of the described embodiments into a single device.

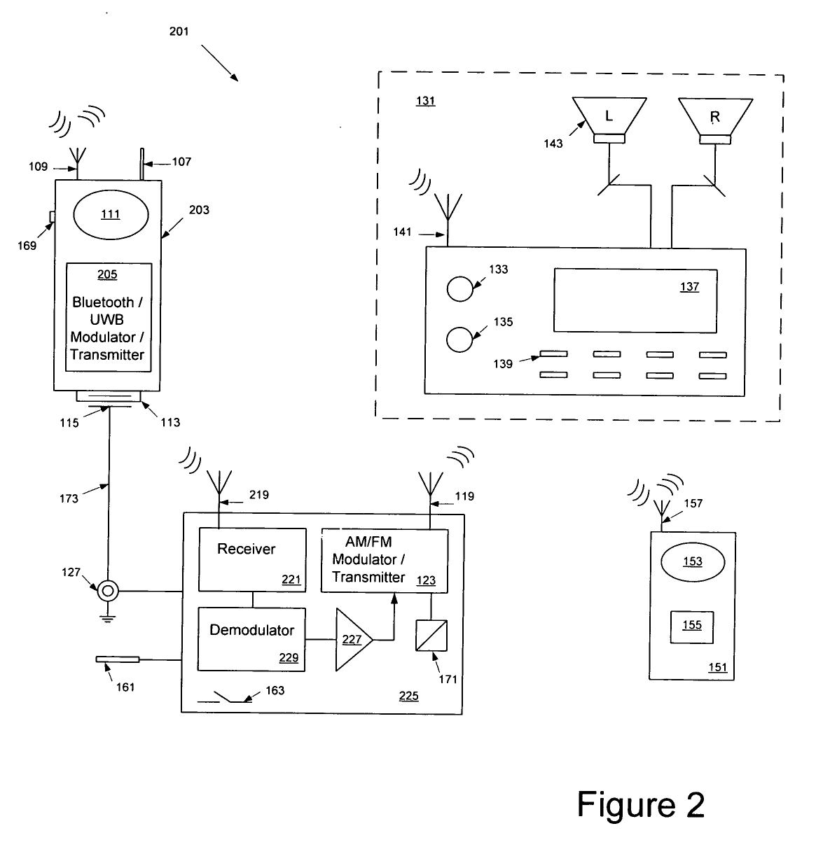

Shown in FIG. 2 with more particularity is the embodiment 201, wherein device 203 and bridge 225 are configured for wireless connection using an intermediate transmission protocol such as Bluetooth and/or UWB. In this embodiment block 205 decodes the downloaded information into a digital file as well as encodes the downloaded digital content using the parameters of the intermediate transmission protocol such as Bluetooth and/or UWB. If the content is compressed, in some embodiments the content is sent after block 205 decompresses it. In other embodiments, the content is passed in its compressed form. If provided to bridge 225 in its compressed form, then bridge 225 would be configured with the requisite hardware and/or software for decompression. As mentioned before, MP3 is a common compression protocol for audio content and MPEG is a common compression protocol for video content (including audio). Device 203, vis-à-vis its modulator 205 and antenna 109, encodes and broadcasts the content using one or more intermediary transmission protocols. Bridge 225 is configured to receive the broadcast content vis-à-vis its antenna 219 that is coupled to a receiver 221. Receiver 221 and demodulator 229, configured to decode one or more intermediary transmission protocols, receive and derive the content from the received signal. If the content is received in its compressed form, such as MP3 or MPEG formats, demodulator 229 further decompresses it. The digital content is then conditioned and/or converted at 227 to an analog signal. The analog signal is provided to modulator 123. Depending on the chosen embodiment, modulator 123 FM or AM modulates the signal onto a carrier frequency and transmits it through antenna 119 to antenna 141 of audio system 131. The carrier frequency is either predefined or is chosen vis-à-vis selector 171. Audio system 131 in turn demodulates the signal and displays its content through one or more speakers 143.

As above, power is provided to bridge 225 from a power source 127, which typically ranges from 11 Vdc to 15 Vdc. In one of the embodiments power source 127 is accessible through the cigarette lighter port typically available in a vehicle. However, any port having one or more power outputs will suffice. Depending on the design, the power is then conditioned and channeled via path 173 to bridge 225 and optionally to device 203. Device 203 may use such power availability to recharge its internal power reserves. At 203, path 173 terminates in a connector 115 compatibly suitable for connection with connector 113. In an alternate embodiment power source 127 represents battery power reserves available internally or externally to bridge 225. Once again, one may extend that reserve to device 103 via path 173.

Shown is a microphone 161 allowing the user to communicate with another party over device 103 or to provide audible commands to device 203, bridge 225 and/or any other device in the system. Microphone 161 may be integrated into bridge 225 and/or path 173. However, microphone 161 may be placed at any point in the vicinity of the user. In one embodiment, path 173 may be configured as a stretchable wire coil. As a coil, the physical connection is more manageable and efficient, especially in a relatively confined space typical of a vehicle environment. Such design is more compact and yet it accommodates some movement while minimizing the wire tangling associated with longer wired paths. One or more switches and/or soft switches 163 may be employed to switch on and off the functionality of bridge 225 and/or mute microphone 161. Switch 163 could also be used to pick up an incoming call or terminate a call.

Bridge 225 may also be integrated with path 173 and/or into the male cigarette lighter plug typically associated with an in-cabin power connection. Such plugs typically accommodate enough physical space for the user to grip and insert the plug into the female power receptacles. In one embodiment, bridge 225 is integrated into the body of the male plug 127. Of course, such integration is not functionally necessary, although logically desirable for efficiency and aesthetics. Bridge 225 could also be designed as a separate physical module configured for interoperability as described throughout this disclosure.

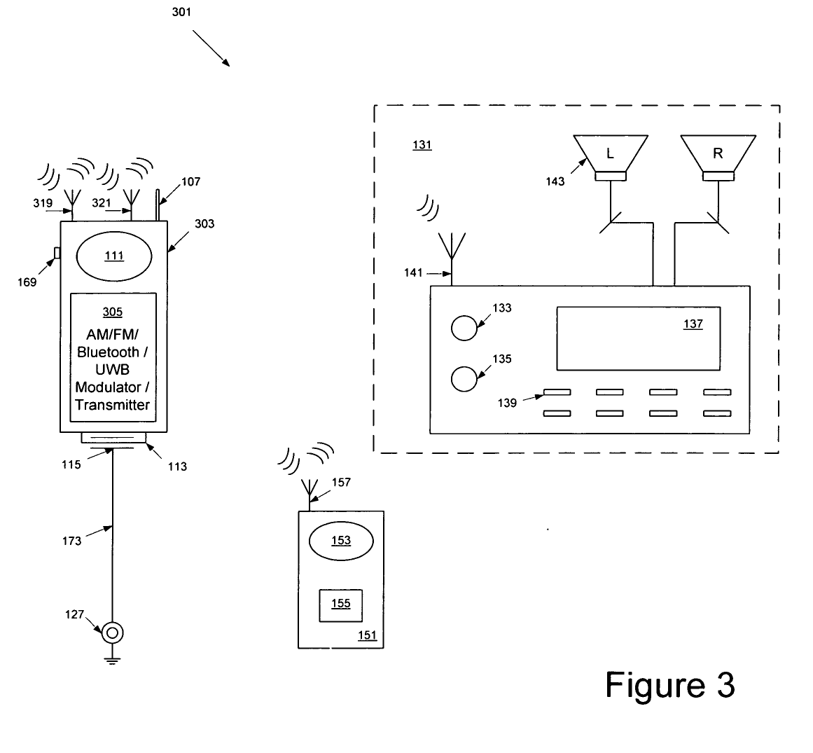

FIG. 3 illustrates an alternate embodiment 301. In this system the functionality of device 103 and bridge 225 are integrated into a wireless communication device 303. In this embodiment device 303 receives the downloaded content as described above. The modulator/transmitter 305 is configured to decode, decompress (if needed) and extract the downloaded content and then transmit the same to device 151, consistent with the intermediary transmission protocols described above. The modulator/transmitter 305 additionally has the capability of converting the downloaded content to an analog signal as described above, and FM or AM modulating the analog signal for transmission to audio system 131 vis-à-vis antenna 321. Also shown is antenna 319, which is used for the described intermediary (Bluetooth and/or UWB as examples) transmission. Audio system 131 in turn demodulates the signal and displays its content through one or more speakers 143. As in other embodiments, power is optionally provided to bridge 125 from a power source 127 via path 173. Device 303 may use such power availability to recharge its internal power reserves. At 303, path 173 terminates in a connector 115 compatibly suitable for connection with connector 113. In an alternate embodiment power source 127 represents battery power reserves available internally or externally to device 303.

An internal microphone is typically available as an integral component of device 303, allowing the user to send communicate back to communicate with another party over the device 303 or to provide audible commands to device 303 and/or any other device in the system. The disclosed embodiments also allow the audio content of an incoming call to be displayed over audio system 131 through encoder 305. In view of the disclosed embodiments herein, the voice content that is ordinarily displayed through one or more audio transducers 111 or 153 could be channeled through encoder 305 and to audio equipment 131 for display through speaker(s) 143.

Notably, depending on the specification of the chosen intermediary transmission protocol, it may be possible to combine antennas 107 and 109; or in the case of the embodiment illustrated in FIG. 3, combine one or more antennas 107, 319 or 321. However, again depending on the protocol specification, it may be advantageous or necessary to use separate antennas. Also worth noting is that other intermediary protocols, such as 802.11, may be used without affecting the scope of the various embodiments disclosed throughout this specification.

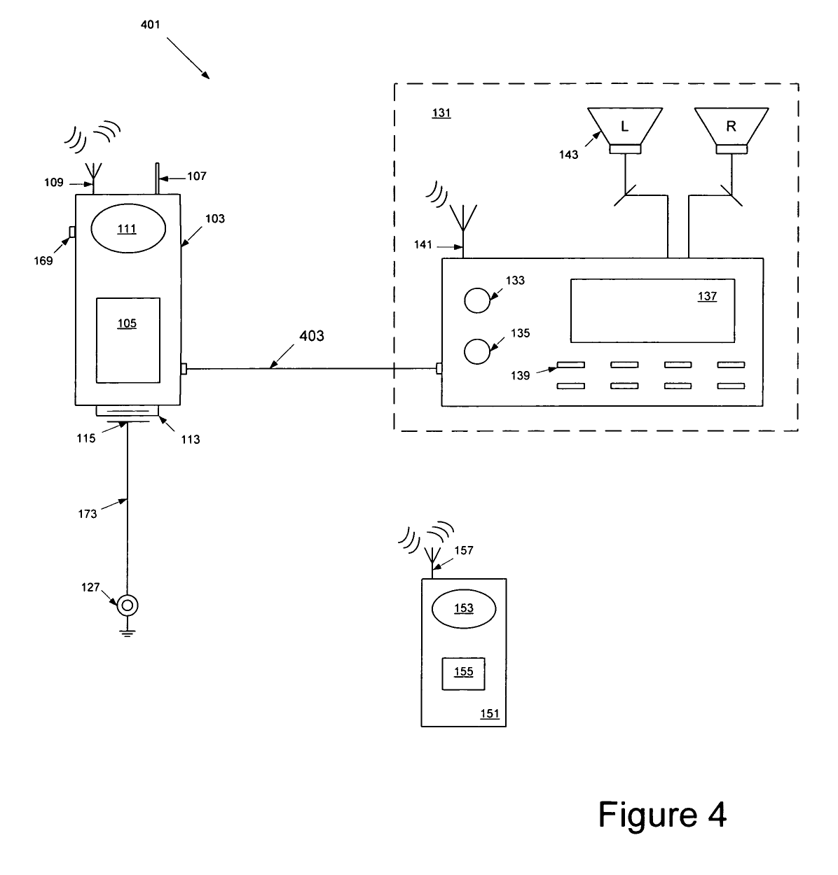

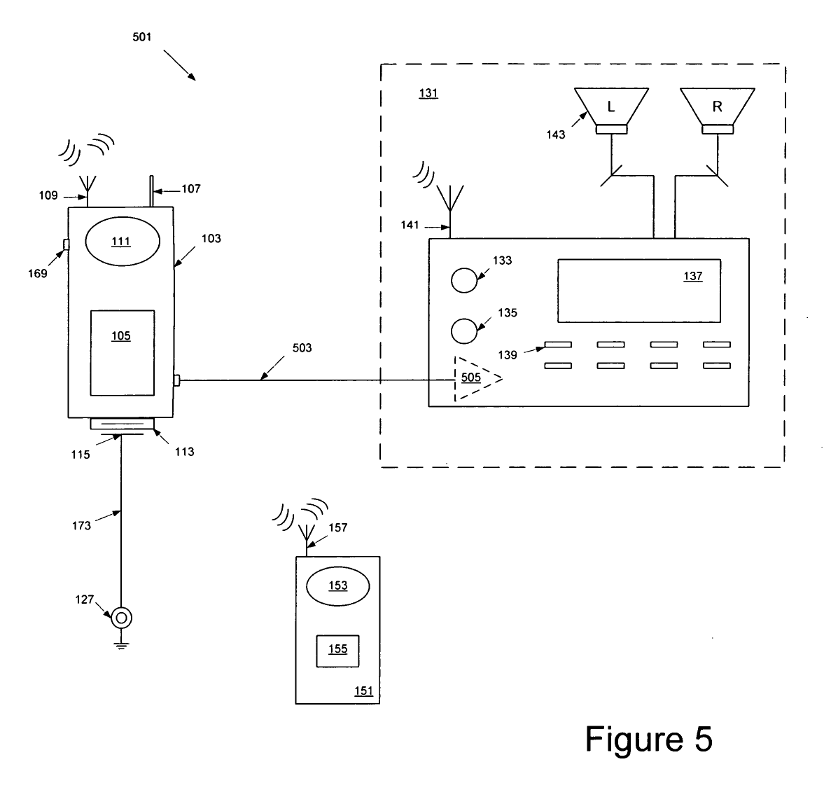

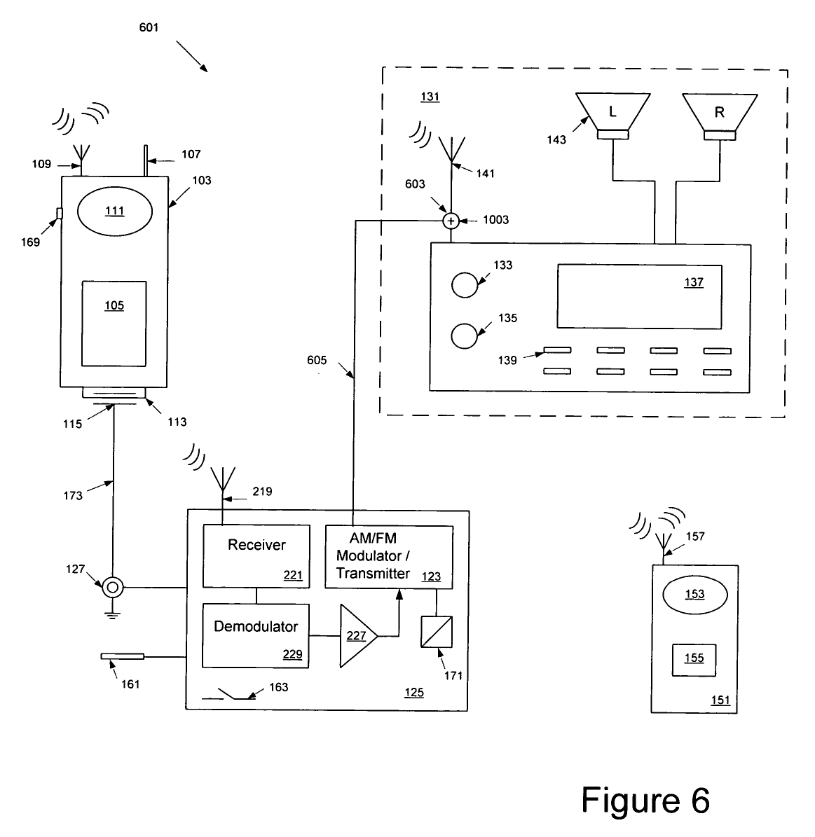

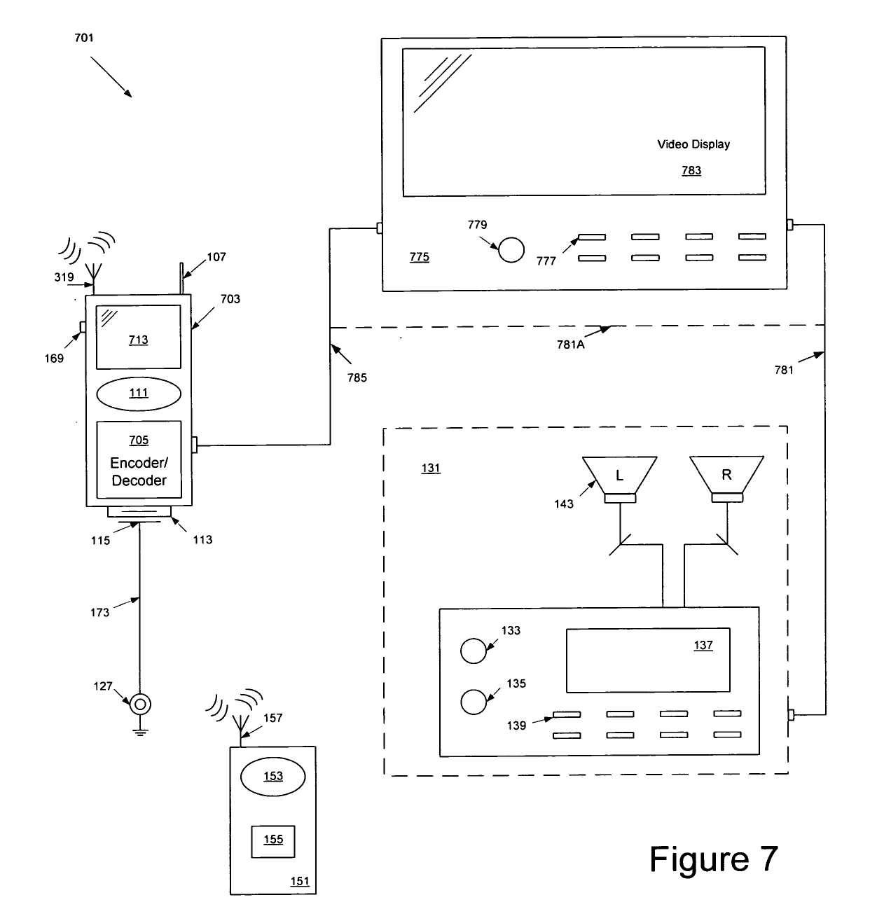

Shown in FIG. 4 is an alternate embodiment 401 providing a physical link/path 403 between device 103 and audio equipment 131. Path 403 could be of any kind, including without limitation one or more RCA cables, a cable with a proprietary connector or a USB connection. This embodiment provides for high throughput and high fidelity. In one embodiment path 403 could also comprise an analog dongle such as a cassette feed, where the audio content is provided to the cassette head of the audio system 131. In another embodiment path 403 is a cable facilitated by a dedicated in-car cradle configured to receive communication device 103. Thus, path 403 would be anticipated by the cradle, either as a dedicated connection or through the connector 113. As described above, the audio content would then be transported to audio system 131 for amplification and display through one or more of its speakers/audio transducers 143.

FIG. 5 is an alternate embodiment 501 of the system shown in FIG. 4. In this embodiment the audio content is transported in its digital form to audio system 131 via a path 503. Digital to analog converter 505 receives the digital stream either directly or via a memory and converts it to an analog signal, which is then amplified and displayed through one or more of its speakers/audio transducers 143. As described above, path 503 may be facilitated by a dedicated in-car cradle configured to receive communication device 103. Thus, path 503 would be anticipated by the cradle, either as a dedicated connection or via the connector 113.

FIG. 6 is an alternate embodiment 601 incorporating bridge 125, as described in FIG. 2 above, further incorporating a physical path 605 between bridge 125 and audio system 131. This embodiment enhances the quality of the audio display by bringing the audio signal, in a form of a RF signal, to the antenna input of audio system 131, instead of transmitting it wirelessly. This eliminates the typical noise and radio transmission issues. Path 605 delivers the FM or AM modulated signal from modulator 123 to a connector 603, coupling the signal to the input of audio system 131. From that point, audio equipment 131 processes/amplifies the signal and displays it through audio transducers 143.

FIG. 7 illustrates an embodiment 701 employing a communication device 703 comprising capabilities to receive video files from a remote source or depository. The video files are downloaded by or to communication device 703. Because video files are relatively large, they are typically compressed on the sending end, received and decompressed on the receiving end by an encoder/decoder 705 (either as a single device or a chipset). A number of compression algorithms are available and are within the scope of the described embodiments. The predominant compression/decompression algorithms employed by the industry are MPEG and most recently H.264 (throughout jointly or severally “MPEG”). H.264 is also known as MPEG-4 AVC (Advanced Video Coding). It is a video compression standard that offers significantly greater compression than its predecessors. The standard is expected to offer up to twice the compression of the current MPEG-4 ASP (Advanced Simple Profile), in addition to improvements in perceptual quality. The H.264 standard can provide DVD-quality video at under 1 Mbps, and is considered promising for full-motion video over wireless, satellite, and ADSL Internet connections. To that end, device 703 employs a memory (not shown) for temporarily or long term storage of the downloaded files. The downloaded file is then decoded and decompressed and depending on the application is either streamed to an onboard screen 713 and audio display 111 or it is stored for subsequent use. Because the screen 713 is limited to the size of the communication device 703, which is typically small, the user may wish to display the video and audio information to a larger screen or alternate screen, such as one of an entertainment system in a vehicle. Such systems typically offer a better quality audio and visual display than a portable communication device. Accordingly, encoder/decoder 705 decompresses the received MPEG stream, display it on the integrated display 713 and audio transducer/speaker 111. In the alternative or in combination, the decompressed video content may be sent to display 775 and its monitor/video display 783 as a derived analog signal or as a digital stream via a path 785. Depending on the configuration, path 785 could be any acceptable interface, such as DVI, a RGB, S-video, or a simple cable for a composite signal. In another embodiment, the functionality of encoder/decoder 705 could be placed with display 775. In this embodiment path 785 would be a cable configured to transport the digital stream from communication device 703 to display 775.

Video display 775 is part of the audio/video system or entertainment system in a vehicle. Display 775 comprises controls 777 and 779 configured as one or more turn knobs 779 and/or push buttons 777. One or more settings for audio and visual displays could be controlled through such controls 777, 779, 133, 135 and/or 139, or for that matter through one or more controls of communication device 703. Other controls such as touch-screen or voice control could also be used. Video display 783 displays the video received via path 785 from communication device 703. Typically, such video displays are LCD or plasma displays. Cathode ray tubes are also suitable, but are largely exiting the market place because of their weight and size characteristics. The audio portion of the content is fed from display 775 to audio system 131 via a path 781, where it is amplified and displayed through one or more speakers/audio transducers 143. However, alternatively the audio signal could be channeled directly to audio system 131 via path 781A.

FIG. 8 illustrates an alternate embodiment 801 employing a bridge 825. In this embodiment a communication device 803 comprising capabilities to receive video files from a remote source or depository. The video files are downloaded by or to communication device 803. Because video files are relatively large, they are typically compressed on the sending end, received and decompressed on the receiving end by an encoder/decoder 805 (either as a single device or a chip set). To that end, device 803 employs a memory (not shown) for temporarily or long term storage of the downloaded MPEG files. The downloaded file(s) is then decoded and decompressed and depending on the application is either streamed to an onboard screen 713 and audio display 111 or it is stored for subsequent use. Because the screen 713 is limited to the size of the communication device 803, which is typically small, the user may wish to display the video and audio information to a larger screen or alternate screen, such as one of an entertainment system in a vehicle. Such systems typically offer a better quality audio and visual display than a portable communication device. Accordingly, encoder/decoder 805 decompresses the received MPEG stream, and displays it on the integrated screen 713 and audio transducer 111. In the alternative or combination, the downloaded content could be provided to a bridge 825 via one or more intermediate protocols such as Bluetooth or UWB (ultra wide band). The intermediary protocol is used to transport the content via antenna 319 of communication device 803 to antenna 819 of bridge 825 and or antenna 157 of device 151. Because communication devices 151 typically employ lower bandwidth intermediary protocols associated with audio, antenna 819 may serve a dual role; i.e. transmitting/receiving UWB signals and/or transmitting/receiving Bluetooth signals. Or, in the alternative, multiple antenna units may be employed. The transported content could be in a digital form as a decompressed MPEG file or compressed MPEG file to conserve bandwidth. At bridge 825 the received signal is coupled to receiver 821, demodulated and/or decoded by demodulator 829 and if sent in compressed MPEG form, decompressed by MPEG decoder 823. The content is then provided to display 775 and its video display 783 via path 885. In embodiments where analog signal is provided to display 775, bridge 825 further employs a digital to analog converter (not shown) and the content signal is coupled to a path 885. As above, path 885 could be a cable for composite video, DVI, or RGB. The audio portion of the content is coupled to audio system 131 either directly from bridge 825 as illustrated as path 781A or through a path 781 between display 775 and audio system 131.

FIG. 9 illustrates an alternate embodiment 901 employing a bridge 925. In this embodiment a communication device 803 comprises capabilities to receive video files from a remote source or depository. As above, the video files are downloaded by or to communication device 803. Because video files are relatively large, they are typically compressed on the sending end, received and decompressed on the receiving end by encoder/decoder 805. To that end, device 803 employs a memory (not shown) for temporarily or long term storage of the downloaded MPEG files. The downloaded file(s) is then decoded and decompressed and depending on the application is either streamed to an onboard screen 713 and audio display 111 or it is stored for subsequent use. Because the screen 713 is limited to the size of the communication device 803, which is typically small, the user may wish to display the video and audio information to a larger screen or alternate screen, such as one of an entertainment system in a vehicle. Such systems typically offer a better quality audio and visual display than a portable communication device. Encoder/decoder 805 decompresses the MPEG stream, and displays it on the integrated screen 713 and audio transducer 111. In the alternative or in combination, the downloaded content could be provided to a bridge 925 via one or more intermediate protocols such as Bluetooth or UWB (ultra wide band). The intermediary protocol is used to transport the content via antenna 319 of communication device 803 to antenna 819 of bridge 825 and or antenna 157 of device 151. Because communication devices 151 typically employ lower bandwidth intermediary protocols associated with audio, antenna 319 may serve a dual role; i.e. transmitting UWB signals and/or transmitting/receiving Bluetooth signals. Or in the alternative, multiple antenna units may be employed. The transported content could be in a digital form as a decompressed MPEG file or compressed MPEG file to conserve bandwidth. At bridge 825 the received signal is coupled to receiver 821, demodulated and/or decoded by demodulator 829 and if sent in compressed MPEG form, decompressed by MPEG decoder 823. In the embodiment of system 901, the decompressed content is coupled to a digital to analog converter (not shown) and to a modulator 991. Modulator 991 modulates the content to a format and frequency used in the country of application using the applicable transmission format (such as NTSC, PAL and HD, as examples) and transmits it through antenna 993 to an antenna 995, which is coupled to video display 775. As before, the produced signal is transmitted through antenna 993 to antenna 995. Such transmissions are foreseeably low power, sufficient to transmit a few meters. The content is then decoded and provided to video display 775 and its video display 783. The audio portion of the content is coupled to audio system 131 either wirelessly received by audio device 131 from system 925 or through a path 781 between display 775 and audio system 131.

FIG. 10 illustrates an alternate embodiment 1001. In this embodiment bridge 825 is integrated with display 775. Accordingly, and as above, the video file(s) is/are downloaded by or to communication device 803. The downloaded file(s) is/are decoded and decompressed and depending on the application is either streamed to an onboard screen 713 and audio display 111 or it is stored for subsequent use. Because the screen 713 is limited to the size of the communication device 803, which is typically small, the user may wish to display the video and audio information to a larger screen or alternate screen, such as one of an entertainment system in a vehicle. Such systems typically offer a better quality audio and visual display than a portable communication device. Accordingly, encoder/decoder 805 decompresses the MPEG stream. Encoder/decoder 805 receives the decompressed video and audio content and encodes for display on video display 783. In the alternative or in combination, the downloaded content could be provided to bridge 825 via one or more intermediate protocols such as Bluetooth or UWB. One or more of the intermediary protocols is/are used to transport the content via antenna 319 of communication device 803 to antenna 1019 of bridge 825 and or antenna 157 of device 151. For example, Bluetooth may be applied to bring audio to device 151 and UWB may be applied to bring video content to antenna 1019. Because communication devices 151 typically employ lower bandwidth intermediary protocols associated with audio, antenna 319 may serve a dual role; i.e. transmitting UWB signals and/or transmitting/receiving Bluetooth signals. Or, in the alternative, multiple antenna units may be employed. The transported content could be in a digital form as a decompressed MPEG file or compressed MPEG file to conserve bandwidth. At bridge 825 the received signal is coupled to receiver 821, demodulated and/or decoded by demodulator 829 and if sent in compressed MPEG form, decompressed by MPEG decoder 823. In the embodiment of system 1001, the decompressed content is then converted into signals suitable to display device 775 to display the content on display 783 and to provide the audio content to audio device 131 via path 781.

FIG. 11 is a flowchart illustrating the process of receiving audio/video content from a remote depository at 1103; at 1105 processing/decoding the data representing the content and then encoding it in a format that is acceptable by display 775 and/or by audio system 131. At the next step, 1107, the content is displayed on video display 783 or is first further processed or decoded at display 775 and then displayed on the video display 783. At 1109 the corresponding audio content is sent to audio system 131 for amplification and display through audio transducers/speakers 143.

FIG. 1211 is an alternate flowchart illustrating the process of receiving audio/video content from a remote depository at 1203; at 1105 processing/decoding the data representing the content and then encoding it via an intermediary protocol for transmission to bridge 825. At 1207 bridge 825 receives the content from the communication device, decodes it and in some embodiments decompresses the content and then provides the content to display 775 and audio system 131. The foregoing provision is either via a physical path, such as a cable or an RF signal in a format that is acceptable by display 775 and/or by audio system 131. At the next step, 1209, the content is displayed on video display 783 or is first further processed or decoded at display 775 and then displayed on the video display 783. At 1211 the corresponding audio content is sent to audio system 131 for amplification and display through audio transducers/speakers 143.

While the present description has been described herein with reference to particular embodiments thereof, a degree of latitude or modification, various changes and substitutions are intended in the foregoing disclosure. It will be appreciated that in some instances some features of the embodiments will be employed without corresponding use of other features without departing from the spirit and scope of the invention as set forth.

I claim:

1. A cellular telephone comprising an interface to at least one physical path coupling said cellular telephone to an audio system; said cellular telephone configured to receive and decode audio content from a remote depository and to provide said audio content to said audio system via said path.

2. The device of claim 1 wherein said audio content provided to said audio system is in a form of an analog signal.

3. The device of claim 1 wherein said audio content provided to said audio system is in a form of a digital signal.

4. The device of claim 1 wherein said path coupling said cellular telephone and said audio system is a USB cable.

5. The device of claim 1, wherein said audio system further comprises a digital to analog converter for converting said audio content to an analog audio signal and coupling said audio signal to at least one amplifier for amplifying said audio signal and displaying said audio signal through at least one audio transducer.

6. An audio system configured for use with a cellular telephone comprising an interface to at least one physical path configured for coupling said cellular telephone to said an audio system; wherein said cellular telephone is configured to receive and decode audio content from a remote depository and to provide said audio content to said audio system via said path.

7. The device of claim 6 wherein said audio content provided to said audio system is in a form of an analog signal.

8. The device of claim 6 wherein said path is coupled to an antenna input of said audio system.

9. The device of claim 6 wherein said path is coupled to an audio input of said audio system.

10. The device of claim 6 wherein said audio content provided to said audio system is in a form of a digital signal.

11. The device of claim 6 wherein said path coupling said cellular telephone and said audio system is a USB cable.

12. The device of claim 6, wherein said audio system further comprises a digital to analog converter for converting said audio content to an analog audio signal and coupling said audio signal to at least one amplifier for amplifying said audio signal and displaying said audio signal through at least one audio transducer.

13. A device comprising:
a) a bridge configured to receive a signal from a wireless communication device, wherein said wireless communication device is configured to wirelessly receive audio content from a remote depository, and to provide to said bridge said audio content as said signal;
b) said bridge configured to modulate said signal onto a carrier frequency; and
c) a physical path coupling said signal to an antenna input of an audio system.

14. The device of claim 13 wherein said physical path is an antenna cable coupling said modulated carrier frequency to said audio system.

15. A cellular telephone comprising an interface configured for at least one physical path coupling said cellular telephone to at least one of a video display and audio system; said cellular telephone configured to receive and decode at least one of video and audio content from a depository and to provide said at least one video and audio content to said at least one of video display and audio system via said at least one path.

16. The device of claim 15 wherein said at least one of video and audio content is provided to at least one of said video display and audio system is in a form of an analog signal.

17. The device of claim 15 wherein said at least one path is a DVI cable.

18. The device of claim 15 wherein said at least one path is a RGB cable.

19. The device of claim 15 wherein said path is a cable suitable for transmission of video signals.

20. The device of claim 15 wherein said video display is a liquid crystal display.

21. A device comprising:
a) a receiver configured to receive and demodulate at least one of video content and audio content from a wireless communication device via an intermediary protocol, wherein said wireless communication device is configured to wirelessly receive said at least one of video content and audio content from a depository; and
b) said device further configured to provide said at least one video content and audio content to at least one of a video display and an audio system.

22. The device of claim 21 wherein said intermediary protocol is a Bluetooth protocol.

23. The device of claim 21 wherein said intermediary protocol is an Ultra Wide Band protocol.

24. The device of claim 21 further comprising an interface configured for connecting said device with said at least one of video display and audio system via a physical path.

25. The device of claim 21 wherein said path is a DVI cable.

26. The device of claim 21 wherein said path is a RGB cable.

27. The device of claim 21 wherein said path is a cable suitable for transmission of video signals.

28. The device of claim 21 further comprising a demodulator for demodulating said at least one of video content and audio content from said intermediary protocol.

29. The device of claim 21 further comprising a MPEG decoder to decompress said at least one of video content and audio content received from said communication device.

30. The device of claim 21 further comprising a modulator for modulating a second intermediary signal comprising said at least one video content and audio content onto a carrier frequency for short range transmission to a remote receiver coupled to said at least one of video display and audio system.

31. The device of claim 30 wherein said second intermediary signal is compatible with at least one of terrestrial television protocols.

32. The device of claim 30 wherein said second intermediary signal is a short range signal.

33. The device of claim 21 further comprising a MPEG decoder, wherein said MPEG decoder is coupled to said demodulator and configured for decoding said at least one video content and audio content.

34. The device of claim 21 wherein said device is integral to said at least one of video system and audio system.

35. A device comprising:
a) a receiver means for receiving and demodulating at least one of video content and audio content from a wireless communication device means via an intermediary protocol means for transporting data wirelessly, wherein said wireless communication device means is configured for wireless reception of said at least one of video content and audio content from a depository; and
b) said device means further configured for providing said at least one video content and audio content to at least one of a video display and an audio system.

36. A method for receiving and displaying video and audio through a display and audio system in a vehicle comprising: downloading content from a remote depository to a wireless communication device; decoding said content in an encoder/decoder of said wireless communication device; transmitting said content to an intermediary bridge via at least one intermediate protocol; modulating said content into a signal acceptable to at least one of said display and said audio system and providing said content to at least one of said display and audio system.
